(19) United States
(12) Patent Application Publication
(10) Pub. No.: US 2006/0245198 A1
(43) Pub. Date: Nov. 2, 2006

(54) High intensity discharge bulb adapter for vehicles

(76) Inventors: Tse-Yang Chen, Shu Lin City (TW); De-Yi Cheng, Shu Lin City (TW)

Correspondence Address: LEONG C LEI, PMB # 1008, 1867 YGNACIO VALLEY ROAD, WALNUT CREEK, CA, 94598, US

(21) Appl. No.: 11/118,415

(22) Filed: May 2, 2005

(51) Int. Cl. B60Q 1/00

(52) U.S. Cl. 362/459

(57) ABSTRACT

A high intensity discharge bulb adapter for a vehicle which includes a base formed with a cylindrical portion having an axial hole, an intermediate portion of the axial hole having a neck portion, the cylindrical portion a high intensity discharge bulb engaging end and a power engaging end, an inner wall of the neck portion having two opposite longitudinal grooves connecting the high intensity discharge bulb engaging end and the power engaging end, the longitudinal grooves being adapted to receive two positioning pins of a high intensity discharge bulb thereby enabling the two positioning pins from moving along the grooves to engage with a power socket, and a sleeve having an axial opening adapted to receive the cylindrical portion, whereby the high intensity discharge bulb can be easily mounted on the lamp hood via the adapter without paying someone else to do it.

### BACKGROUND OF THE INVENTION

(a) Field of the Invention

The present invention relates to a high intensity discharge bulb adapter for vehicles, and in particular to an adapter which can connect a high intensity discharge bulb to a conventional lamp hood for vehicles.

(b) Description of the Prior Art

The brightness and clearness of the regular light bulbs currently in use for motor vehicle lamps are inferior to the High Density Discharge (HID) bulbs. Hence, in order to increase invisibility at night, more and more vehicle owners are switching from traditional light bulbs to HID bulbs.

However, the structure of the light bulbs used in traditional vehicle lamp is different from that of the HID light bulbs. Therefore the HID light bulbs cannot be directly engaged with the original lamp hood for vehicles. This has necessitated the replacement of the existing vehicle lamp fixture, by a fixture that accommodates the HID light bulb, or alternatively, a refitting of the existing lamp fixture. Nonetheless, either the replacement or the refitting is an extremely cumbersome and costly task. Furthermore the vehicle owner himself cannot carry such task. Hence, there is a need for improvement.

Therefore, it is an object of the present invention to provide ad adapter which can engage a high intensity discharge bulb with a conventional lamp hood for vehicles.

### SUMMARY OF THE INVENTION

It is the primary object of the present invention to provide a high intensity discharge bulb adapter for a vehicle which includes: a base formed with a cylindrical portion having an axial hole, an intermediate portion of the axial hole having a neck portion which is smaller than the axial hole in diameter, the cylindrical portion having a first end defined as a high intensity discharge bulb engaging end and a second end defined as a power engaging end, an inner wall of the neck portion having two opposite longitudinal grooves connecting the high intensity discharge bulb engaging end and the power engaging end, the longitudinal grooves being adapted to receive two positioning pins of a high intensity discharge bulb thereby enabling the two positioning pins from moving along the grooves to engage with a power socket, and a sleeve having an axial opening adapted to receive the cylindrical portion, the sleeve being provided with a plurality of longitudinal holding arms for engaging with a lamp hood of a vehicle, whereby the high intensity discharge bulb can be mounted on the lamp hood via the adapter.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention;

FIG. 2 is another exploded view of the present invention;

FIG. 3 is a perspective view of the present invention engaged with a high intensity discharge bulb;

FIG. 4 illustrates the disengagement between the lamp hood and the present invention;

FIG. 5 illustrates the engagement between the lamp hood and the present invention; and

FIG. 6 is a side view of the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

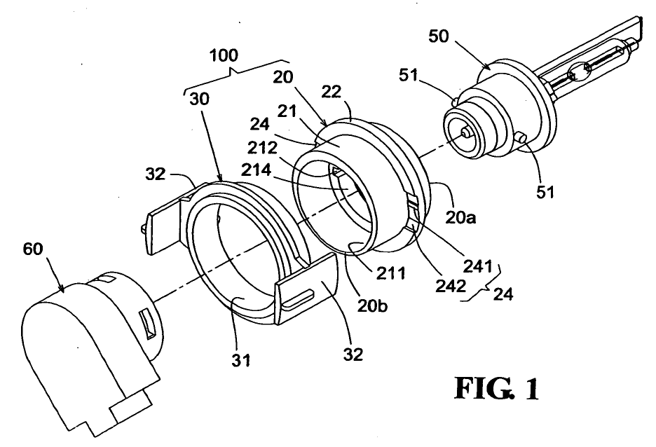

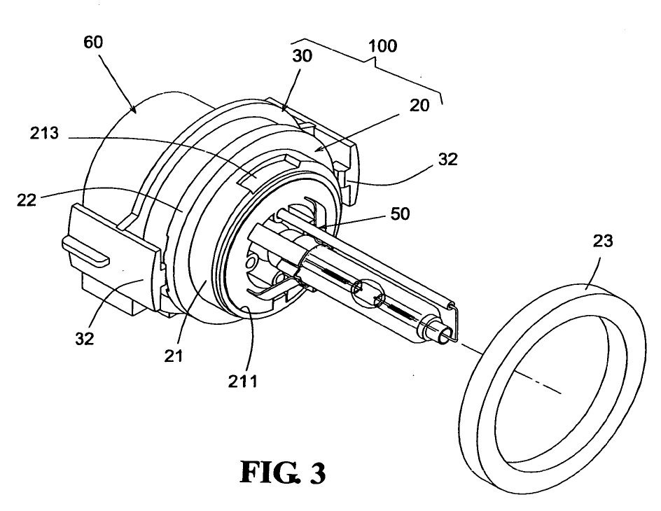

Referring to FIGS. 1, 2 and 3, the high intensity discharge bulb adapter 100 according to the present invention comprises a base 20 and a sleeve 30. The base 20 is formed with a cylindrical portion 21 having an axial hole 211. The intermediate portion of the axial hole 211 has a neck portion 214 having a smaller inner diameter than the axial hole 211. The cylindrical portion 21 has a first end defined as a high intensity discharge bulb engaging end 20a, and a second end defined as a power engaging end 20b. The inner wall of the neck portion 214 is formed with two opposite longitudinal grooves 212 connecting the high intensity discharge bulb engaging end 20a and the power engaging end 20b, so that the two positioning pins 51 of a high intensity discharge bulb 50 can move along the grooves 212 from the high intensity discharge bulb engaging end 20a to the power engaging end 20b so as to engage with a power socket 60. The sleeve 30 has an axial opening 31 adapted to receive the cylindrical portion 21 of the base 20. The sleeve 30 is provided with a plurality of longitudinal holding arms 32 for engaging with a lamp hood 70 of a vehicle thereby enabling the high intensity discharge bulb 50 and the power socket 60 to be engaged with the lamp hood 70 of a vehicle.

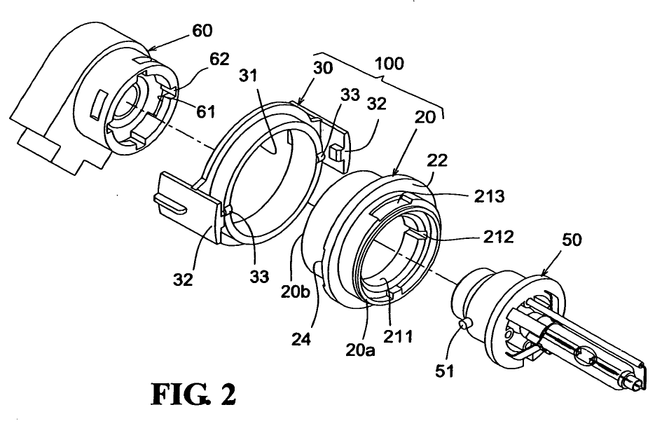

Referring to FIGS. 1 and 2, the cylindrical portion 21 of the base 20 is formed with a flange 22 adapted to engage with a lamp socket. The high intensity discharge bulb engaging end 20a of the cylindrical portion 21 has a recess 213 adapted to receive a positioning member (not shown) of the lamp socket.

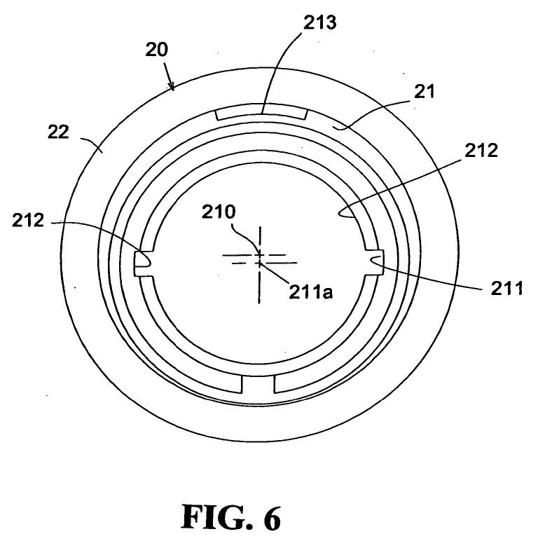

Referring to FIGS. 1, 2, 5 and 6, the center 210 of the outer side of the cylindrical portion 21 is eccentric from the center 211a of axial hole 211, so that when a high intensity discharge bulb 50 engaged with the axial hole 211 is engaged with the lamp hood, the high intensity discharge bulb 50 can be adjusted to be arranged at the correct focus of the lamp hood 70.

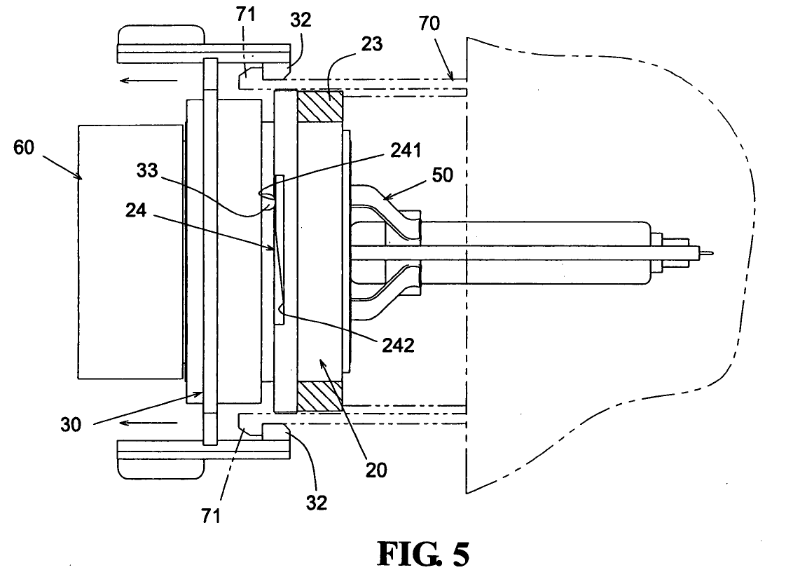

Referring to FIGS. 1, 2, 4 and 5, the sleeve 30 is provided at the front end with two opposite protuberances 33 which are slidably engaged with cam surfaces 24 of the flange 22. As shown in FIG. 5, when the sleeve 30 is rotated to move the protuberance 33 to a first section 241 of the cam surface 24, the sleeve 30 will be moved towards the power socket 60 thereby tightening the engagement between the holding arms 32 and positioning hooks 71 of the lamp hood 70. On the contrary, when the sleeve 30 is rotated to move the protuberance 33 to a second section 242 of the cam surface 24, the sleeve 30 will be moved towards the lamp hood 70 thereby releasing the engagement between the holding arms 32 and the positioning hooks 71 of the lamp hood 70 and therefore enabling the adapter 100 to be released from the lamp hood 70 for replacing the high intensity discharge bulb 70.

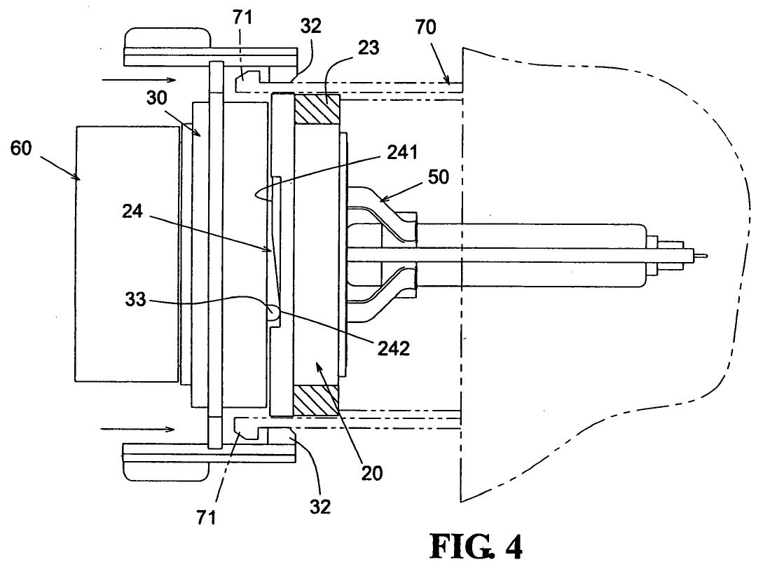

As shown in FIGS. 4 and 5, a packing ring 23 is fitted between the front end of cylindrical portion 21 of the base 20 and the lamp hood 70.

Referring to FIGS. 1 through 5, when in assembly, the positioning pins 51 of the high intensity discharge bulb 50 are first aligned with the grooves 212 of the neck portion 214 of the base 20 and then moved through the high intensity discharge bulb engaging end 20a and the power engaging end 20b to grooves 62 of the power socket 60, and thereafter, the power socket 60 is turned to keep the positioning pins 51 of the high intensity discharge bulb 50 in the slot 61 thereby keeping the high intensity discharge bulb 50 in place. Finally, the sleeve 30 is turned to engage the holding arms 32 with the positioning hooks 71 of the lamp hood 70.

Accordingly, it is unnecessary to modify or replace the lamp hood 70 for engaging the high intensity discharge bulb 50 thus lowering the cost and enabling the assembly to be easily accomplished without paying someone else to do it.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high intensity discharge bulb adapter for a vehicle comprising:
a base formed with a cylindrical portion having an axial hole, an intermediate portion of said axial hole having a neck portion which is smaller than said axial hole in diameter, said cylindrical portion having a first end defined as a high intensity discharge bulb engaging end and a second end defined as a power engaging end, an inner wall of said neck portion having two opposite longitudinal grooves connecting said high intensity discharge bulb engaging end and said power engaging end, said longitudinal grooves being adapted to receive two positioning pins of a high intensity discharge bulb thereby enabling said two positioning pins from moving along said grooves to engage with a power socket; and
a sleeve having an axial opening adapted to receive said cylindrical portion, said sleeve being provided with a plurality of longitudinal holding arms for engaging with a lamp hood of a vehicle;
whereby said high intensity discharge bulb can be mounted on said lamp hood via said adapter.

2. The high intensity discharge bulb adapter for a vehicle as claimed in claim 1, further comprising a cushioning packing fitted on said first end of said cylindrical portion.

3. The high intensity discharge bulb adapter for a vehicle as claimed in claim 1, wherein a center of an outer side of said cylindrical portion is eccentric from a center of said axial hole.

4. The high intensity discharge bulb adapter for a vehicle as claimed in claim 1, wherein said sleeve has an end provided with two opposite protuberances which are slidably engaged with two cam surfaces formed on a flange of said cylindrical portion, so that when said sleeve is rotated to move said protuberances to a first section of said cam surfaces, said sleeve will be moved towards said power socket thereby tightening engagement between said holding arms and positioning hooks of said lamp hood, and when said sleeve is rotated to move said protuberances to a second section of said cam surfaces, said sleeve will be moved towards said lamp hood thereby releasing engagement between said holding arms and said positioning hooks of said lamp hood.
